(19) United States
(12) Patent Application Publication
(10) Pub. No.: US 2003/0001739 A1
(43) Pub. Date: Jan. 2, 2003

(54) Electronic article surveillance antenna for attachment to a vertical structure

(76) Inventors: Robert Clucas, Pompano Beach, FL (US); Paul G. Coulson, Boca Raton, FL (US); Gilbert Fernandez, Weston, FL (US); Jan B. Forney, Boca Raton, FL (US); Franklin H. Valade JR., Boynton Beach, FL (US)

Correspondence Address: SENSORMATIC ELECTRONICS CORPORATION, 6600 CONGRESS AVENUE, BOCA RATON, FL, 33487, US

(21) Appl. No.: 09/896,879

(22) Filed: Jun. 29, 2001

(51) Int. Cl. G08B 13/14

(52) U.S. Cl. 340/572.1; 340/572.7; 340/572.8; 340/10.3

(57) ABSTRACT

An acousto-magnetic electronic article surveillance antenna is provided that attaches directly to a vertical structure with the electromagnetic field projected across an opening, such as an exit or entrance to a building or other defined area. The vertical structure could be a doorframe or wall, constructed from a wide variety of materials, including metal, wood, glass, concrete or gypsum wallboard. The antenna geometry is elongated vertically to allow a corresponding decrease in width projected from the vertical structure, thereby reducing the apparent size of the antenna and providing a near-concealed appearance and protection form physical damage.

### CROSS REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention relates to electronic article surveillance (EAS) antennas, and more particularly to magnetomechanical EAS antennas mountable to a vertical structure.

2. Description of the Related Art

In the high fashion retail marketplace, retailers have a strong preference for discreet electronic article system protection. In locations where electronic article surveillance antennas are required and must be visible to pedestrian traffic, it is advantageous to conceal the antennas to the greatest extent possible.

Typical entrances to retail or office spaces have a span of 6 feet (1.8 meter) or greater to allow unobstructed access. Electronic article protection of said entrances requires projecting an electromagnetic field across the entire entrance of sufficient strength to excite a corresponding electronic article surveillance marker. The overall size or aperture of the antenna increases in direct proportional to the distance spanned as required to maintain adequate system performance and marker detection. Antenna aperture is also related to the amplitude of the signal from the EAS marker. Magnetomechanical EAS markers are relatively inefficient compared to active or tuned LC markers and require EAS antenna of larger aperture to be detected. These constraints have previously resulted in magnetomechanical antenna designs that are relatively wide, and obstruct the view into a retail environment. In smaller stores, the electromagnetic field generated from these wider antennas not only projects across the entrance, but well into the store display area. Display area must be reduced to prevent false alarms due to detection of EAS markers attached to displayed merchandise.

Fixtures, such as electronic article surveillance antennas, which are affixed in close proximity to the entrance of a retail space are commonly subjected to physical abuse, either by pedestrians directly, shopping carts which may be quite heavy, or floor cleaning equipment. As a result, the antennas must be capable of withstanding substantial wear over the course of multiple years of operation. Relatively large antennas, as described previously, could not practically attach to a vertical structure, as the increased size would inherently expose them to greater and excessive physical abuse.

The acousto-magnetic or magnetomechanical electronic article surveillance antennas, located in close proximity to an entrance, are commonly mounted to the floor. The terms acousto-magnetic and magnetomechanical are used interchangeably herein and refer to EAS markers such as those disclosed in U.S. Pat. No. 4,510,489, and to other pulsed magnetic EAS systems. The antennas are oriented to project an electromagnetic field across the entrance. The overall height of an antenna is generally constrained to remain below the eye level of an average adult, or approximately 5 feet (1.5 meter). This height maintains visibilty into the retail environment. Projecting an electromagnetic field across common entrance openings required an antenna aperture width of 12 inches (30 centimeters) or greater resulting in antennas having vertical to horizontal aspect ratios in the range of about 2 to 1 to about 5 to 1. Antennas of this size are easily visible and subject to physical abuse. Other solutions have included placing antennas in the ground or floor structure (buried), or hanging antennas from a ceiling, whereby the antenna electromagnetic field is projected in a vertical direction across the opening. These installations require significant installation time and cost.

As a result of the size requirements above, acousto-magnetic antennas were impractical to mount to a vertical structure, such as to the sides of a doorway, to provide additional floor space and improve the visibility into stores. EAS antennas mountable to such vertical structures and having a narrow aspect ratio, are desired to conceal and protect the antennas, and provide better visibility into the store and additional floor space.

### BRIEF SUMMARY OF THE INVENTION

A magnetomechanical electronic article surveillance antenna mountable to a vertical member is provided that includes at least two coils adapted for generating an electromagnetic field for detecting an electronic article surveillance marker. The coils are elongated in the vertical direction and stacked substantially end to end in substantially the same plane defining an electronic article surveillance antenna having a vertical to horizontal aspect ratio that is relatively much greater in the vertical direction than the horizontal direction. The antenna appears relatively tall and narrow. The coils are driven substantially in phase and out of phase with each other, alternately, to generate the electromagnetic field. An antenna housing is adapted to receive the coils. The housing is attachable to a vertical member where the electromagnetic field generated from the coils is projected substantially into an opening adjacent the vertical member for passage of an electronic article surveillance marker to be detected.

The coils may at least partially overlap near the center of said antenna. The vertical to horizontal aspect ratio can be greater than 7 to 1, and is about 9 to 1 in the preferred embodiment.

An elongated mounting base can be included for connection to a vertical member. The antenna housing is attachable to the mounting base. The antenna housing can be removable and rigidly attachable to the mounting base. The antenna housing can include an electronic housing portion for receiving at least one printed circuit board. The electronic housing portion is adapted to receive the printed circuit board in a first and a second, reversed orientation for selective installation in the electronic housing portion.

Objectives, advantages, and applications of the present invention will be made apparent by the following detailed description of embodiments of the invention.

### BRIEF DESCRIPTION OF THE SEVERAL VIEWS OF THE DRAWINGS

FIG. 1 is a side elevation view of the antenna assembly of the present invention.

FIG. 2 is a side elevation view, partially cutaway, of the antenna assembly of the present invention.

FIG. 3 is a perspective view of one embodiment of the present invention installed in a doorway.

FIG. 4 is a side elevation view of the antenna assembly of the present invention without the auxiliary panels installed.

FIG. 5 is cross-sectional view taken along line 5-5 in FIG. 4.

FIG. 6 is a partially exploded perspective view of the antenna assembly of the present invention.

FIG. 7 is a partial side elevation view, partially cutaway, illustrating the hidden locking features that secure the antenna assembly to the mounting base of the present invention.

FIG. 8 is a partial front elevation view, partially cutaway, of that shown in FIG. 1.

FIG. 9 is a cross-sectional view taken along line 9-9 of FIG. 8.

FIG. 10 is a partial front elevation view of that shown in FIG. 8, with the PCBs reversed.

FIG. 11 is a cross-sectional view of that of FIG. 9 with the PCBs reversed.

FIG. 12 is a partial side elevation view, partially cutaway, of that shown in FIG. 1.

FIG. 13 is a plot of the response of the vertical field for two slightly overlapping coils forming an antenna with an aspect ratio of 1.89 to 1, as in the prior art.

FIG. 14 is a plot of the response of the vertical field for two slightly overlapping coils forming an antenna with an aspect ratio of 8.85 to 1, as in the present invention.

### DETAILED DESCRIPTION OF THE INVENTION

Acousto-magnetic electronic article surveillance antennas are attached directly to a vertical structure with the electromagnetic field projected across an opening, such as an exit or entrance to a building or other defined area. The vertical structure could be a doorframe or wall, constructed from a wide variety of materials, including metal, wood, glass, concrete or gypsum wallboard. Attaching the antenna directly to a vertical structure, such as a door frame, wall or glass store front reduces the visual obstruction when compared to an antenna which is positioned several inches (centimeters), or possibly feet (meters) from the vertical structure. The antenna eye-level height limit in the prior art is overcome by attaching the antenna to a vertical structure. Furthermore, an antenna attached to the edge of an opening tends to blend into the surrounding structure, hence enhancing the discreet characteristic of the antenna system. Furthermore, an antenna attached to the edge of an opening increases the usable retail space in a store.

To permit attachment to a vertical structure, the antenna geometry is elongated vertically to allow a corresponding decrease in width projected from the vertical structure, thus reducing the apparent size of the antenna. The antenna electromagnetic field is enhanced in the vertical direction as a result of the increased antenna height, but reduced in the horizontal and lateral directions due to the reduced antenna width. The reduction in field strength in the horizontal and lateral direction can be overcome to a large degree by utilizing multiple antenna coils to develop the electromagnetic field, and reversing the phase of the current in the coils to allow the field from each coil to sum both when the current is in and out of phase. The net effect is a more uniform antenna electromagnetic field in all orientations.

The individual antenna coils have an intentional asymmetry, which increases the width of the antenna at the center, and tapers off near the top and bottom. The increased width in a limited area increases the electromagnetic field, yet does not appreciably increase the apparent size of the antenna.

The structural integrity of the antenna is accomplished by using a combination of an aluminum extruded mounting base and an antenna structure made by compression molding using glass filled polyester material. The construction of the antenna and materials selected allow the antenna to withstand substantial wear expected from pedestrian traffic and shopping cart impacts.

The antenna can be rigidly affixed to the vertical structure directly or through the utilization of a separate mounting base. The mounting base is rigidly attached to the vertical mounting structure using several optional methods, either in part, or in combination. The back of this mounting base has holes that enable mounting to the vertical structure by using several different type of screws, depending upon the structural materials involved. To enable mounting to glass substrates, very high strength adhesive tape is applied to the back surface of the mounting base. The antenna attaches to the mounting base through mating bayonet features in the antenna and mounting base.

The electronic enclosure, which contains printed circuit board (PCB) assemblies, an alarm counter and function switch are located at the bottom of the antenna assembly. This is the preferred implementation, however, the described circuitry could be located at other locations, the top of the antenna, the central area within the antenna coils, or even remotely. The PCB mounting is reversible to allow access to the PCBs if the antenna is located adjacent to a wall, which could impede access to the PCBs. An alarm assembly is located at the top of the antenna, which provides both audible and visual alarms.

The reduced visual obstruction from using the present invention greatly enhances the visibility into a retail store, allowing a clear view of merchandise from passing shoppers. Reduced visual obstruction is accomplished by attaching the antenna to the edges of the entrance opening, as opposed to a distance inside the opening as in prior antennas. Additionally, the narrow profile of the antenna allows it to blend into the surrounding structure.

Positioning the antenna on the edge of the entrance opening allows retailers to bring merchandise closer to the entrance, thus increasing the amount of valuable retail floor space. This also allows electronic article surveillance systems to be a viable solution for small stores where the interrogation zone of previous solutions was too large for a limited store entrance area. Large interrogation zones that extend too far into a store can detect EAS markers attached to merchandise on display causing false alarms. The design, which is further enhanced when acrylic panels are included, makes this a desirable solution for customers who require high aesthetics at the entrance to their retail or professional space.

The separate mounting base, constructed from high strength materials, such as aluminum, provides the necessary durability to the mounting system, allowing it to withstand physical abuse. The ability to mount the antenna using very high strength adhesive tape provides additional rigidity to the mounting system, and saves time by not requiring drilling into the vertical structure. High strength materials provide great resistance to physical abuse. Reversible PCB assemblies provide greater flexibility in mounting locations. Alarm assemblies provide an audible and visual indication of an EAS marker in the interrogation field.

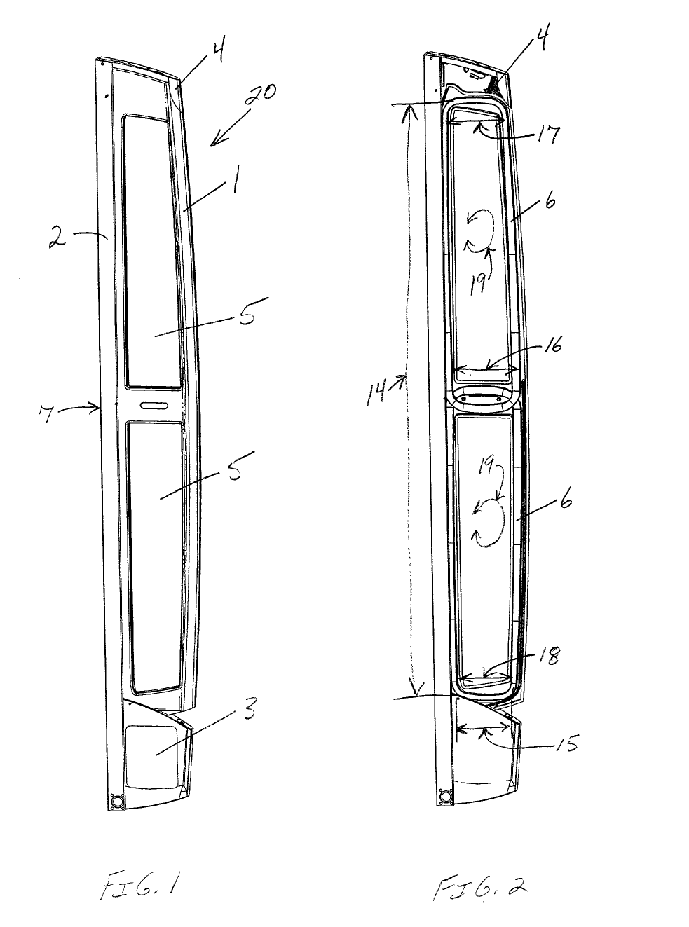

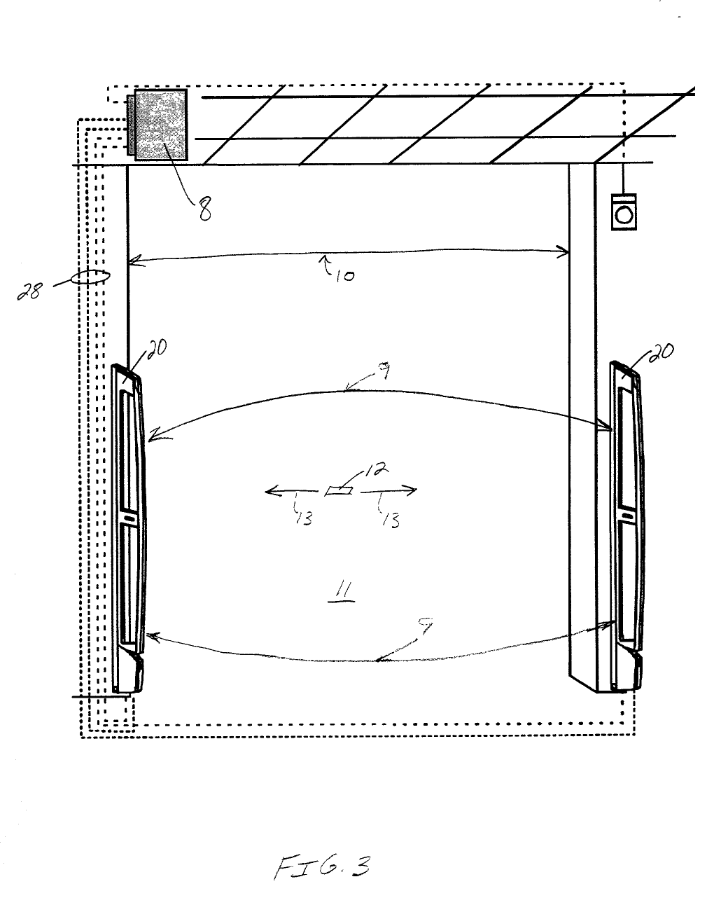

Referring to FIGS. 1 and 2 the acousto-magnetic EAS antenna assembly (20) is illustrated. The antenna assembly (20) includes the antenna structure (1), mounting base (2), electronics enclosure (3), alarm assembly (4) and auxiliary acrylic panels (5). The antenna structure (1) contains wound antenna coils (6), which oriented such that the lateral ends of each extend away from the vertical mounting surface (7). The antenna coil geometry is elongated in the vertical direction (14) compared to the horizontal direction (15) that extends away from the vertical mounting surface. To obtain the elongated vertical antenna geometry the coils (6) are stacked end to end and lie substantially in the same plane. Within the same plane means the same plane or adjacent planes so that the coils are mountable to a vertical structure and such that the electromagnetic field generated by each coil (6) together define an interrogation zone for detecting EAS markers. The aspect ratio of the antenna assembly is such that the vertical dimension is substantially greater than the horizontal dimension. The aspect ratio is approximately 9:1 in the preferred embodiment, but aspect ratios varying considerably are contemplated by the present invention, including aspect ratios in the range of about 7 or greater to 1, and providing an antenna that appears relatively tall and narrow as compared to conventional EAS antennas. Two or more antenna coils (6) are utilized to form the antenna assembly. The antenna coils are intentionally asymmetric such that the antenna geometry is wider at the center of the antenna (16) and reduces near the top (17) and bottom (18). This increases the effective aperture of the antenna while minimizing the perceived size. A portion of the coils (6) near the center of antenna assembly (20) can overlap each other.

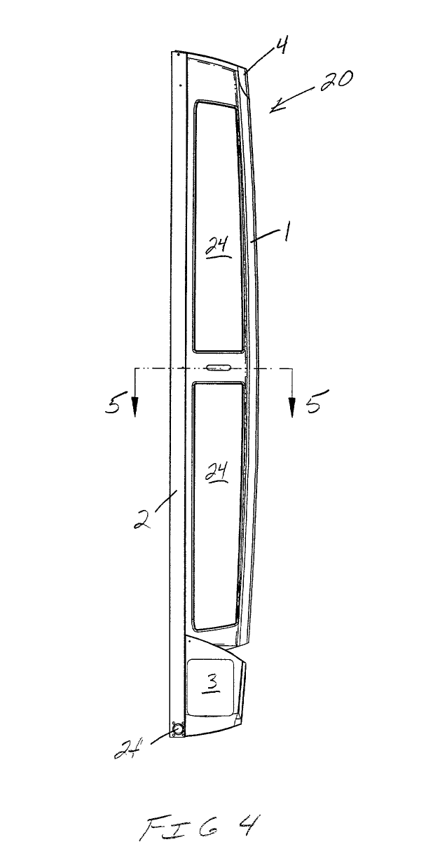

Referring to FIG. 3, current is applied to the coils (6) by a remote electronic controller (8) which develops an electromagnetic field (9) which emanates primarily along the plane of the vertical structure and across the adjacent opening or passageway (10). The electromagnetic field becomes an interrogation zone (11) for electronic article surveillance marker (12). The markers react to the electromagnetic field and emit a return signal (13), which may be received by the antennas, thus indicating the presence of a marker in the interrogation zone. The current is generated in a periodic waveform such that the direction and magnitude of the current through each coil reverses periodically (19), as shown in FIG. 2. Having multiple coils permits driving current through the coils in the same direction simultaneously (in-phase), or in opposite directions (out of phase). U.S. Pat. No. 6,118,378, the disclosure of which is incorporated herein buy reference, discloses one method of driving the coils (6) in this manner. The summation of the electromagnetic field from each coil is thereby controllable, which permits the generation of a more uniform electromagnetic interrogation field (9), and enhances antenna performance. Because the vertical dimension of the antenna assembly (20) is much greater than the horizontal dimension, the electromagnetic field (9) generated is shaped such that more of the field is focused into passageway (10) and less of the field extends over onto the floor space adjacent opening (10). Therefore, merchandise displayed adjacent the passageway (10), having attached EAS markers (12), will not be positioned in the electromagnetic field generated by antenna assembly (20), and will not cause false alarms.

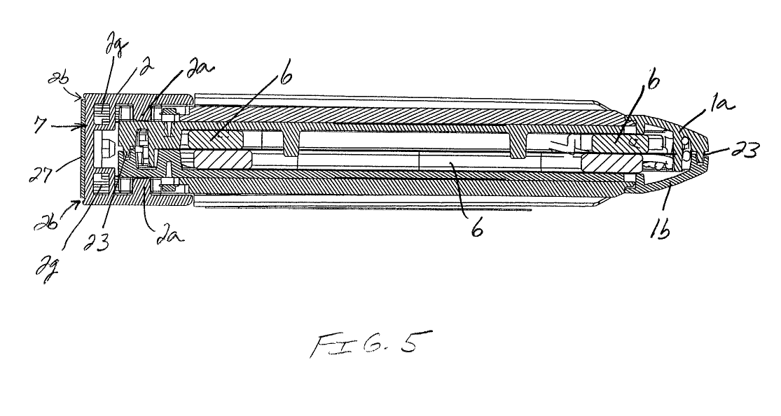

Referring to FIGS. 4 and 5, the antenna structure (1) is an enclosed and separate assembly that is mounted to the mounting base (2). Mounting base (2) is constructed from a high strength material, such as but not limited to aluminum, to provide adequate strength and stiffness if and when the antenna (20) is impacted by heavy objects. Antenna structure (1) consists of two panels (1a, 1b) that are bonded together to form a rigid structure. The antenna may be open (24) to allow visibility through the antenna, and reduce the visible obstruction of the antenna assembly. Auxiliary panels (5), shown in FIG. 1, may be added to customize the appearance of the antenna to meet individual installation requirements. Auxiliary panels (5) could be fabricated from acrylic, to preserve the open look of the antenna, or other attractive materials to provide a rich appearance to the antenna assembly (20), or other materials as desired to improve the durability or otherwise improve the functionality of the antenna assembly (20). Antenna panels (1a, 1b) are preferably made of high strength compression molded glass filled plastic, but can be fabricated from other materials that provides high resistance to physical abuse. The two antenna panels (1a, 1b) are rigidly attached together, using a method such as but not limited to bonding, to create a structural assembly with a high degree of stiffness to improve the durability and strength of the antenna assembly (20). A tongue and groove feature (23) can be located along the periphery of the antenna panels (1a, 1b), to place the adhesive to bond the two panels (1a, 1b) together.

Mounting base (2) includes a recess (2b), on vertical mounting surface (7), where adhesive tape (27) is located. Adhesive tape (27) is used to secure the mounting base (2) to a variety of surfaces, including glass. In addition, several mounting holes are provided through vertical mounting surface (7) which facilitate mounting of base (2) using a variety of conventional screws. The combination of adhesive tape (27) and screws enable attachment of the mounting base (2), and hence antenna assembly (20), to a wide variety of potential mounting surfaces, such as but not limited to metal, wood, glass, concrete or gypsum wallboard, and enhances the strength and durability of the attachment.

Cabling (28) from the system electronic controller (8), as shown in FIG. 3, can interface to the mounting base (2) at locations near the top or bottom of mounting base (2), depending upon the requirements of the instalation. Knockouts (2f) can be provided to interface to commonly used conduit or wire molding. Mounting base (2) incorporates inner channels (2g) for routing cabling (28) from the top of the mounting base (2) to the electronics enclosure (3) near the bottom of the antenna assembly (20). The channels (2g) serve to protect the cabling (28) from potential crushing by the antenna structure (1) during assembly to the mounting base (2).

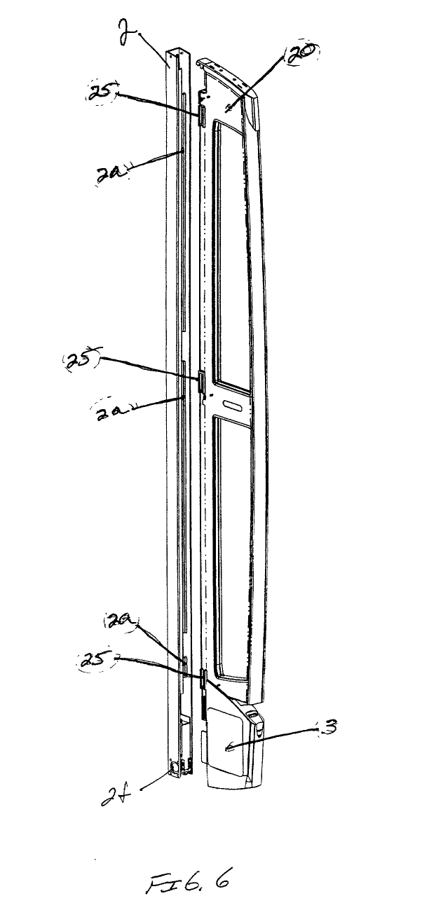

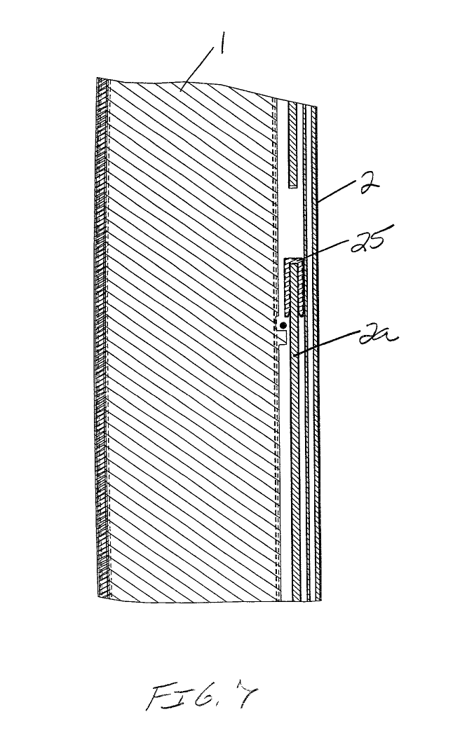

Referring to FIG. 6, antenna structure (1) incorporates hidden locking features that allow mounting of the antenna assembly (20) to the mounting base (2) without the use of screws. The locking feature consists of molded channels (25) on each antenna panel (1a, 1b) and occur at, for example, three locations on each antenna panel (1a, 1b). Molded channels (25) mate to corresponding ribs (2a) on mounting base (2), as shown in FIG. 7. The antenna assembly (20) is inserted into the mounting base (2) and then lowered to engage the ribs (2a) into the molded channels (25) thus locking the antenna assembly (20) into position. The molded channels (25) are tapered such that there is clearance between said channels (25) and the ribs (2a) as they are initially inserted. The clearance is eliminated as the antenna assembly (20) is lowered into the mounting base (2), resulting in a tight fit that holds the antenna assembly (20) firmly in position without rattling. A single screw can be utilized at the bottom of the antenna structure (1) to prevent the antenna assembly (20) from being inadvertently removed from the mounting base (2).

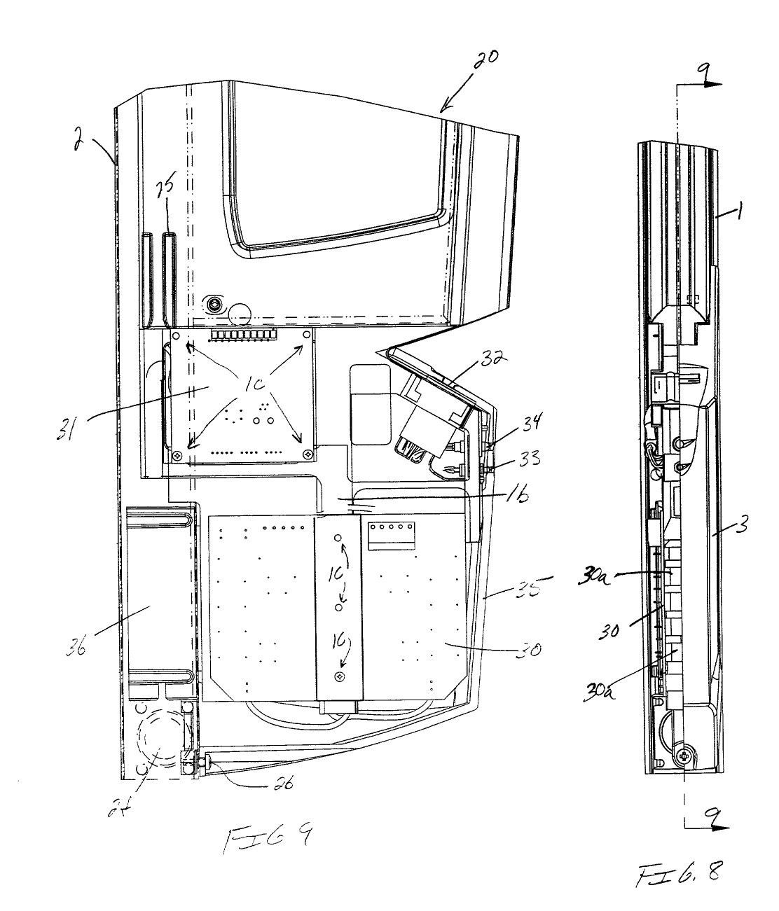

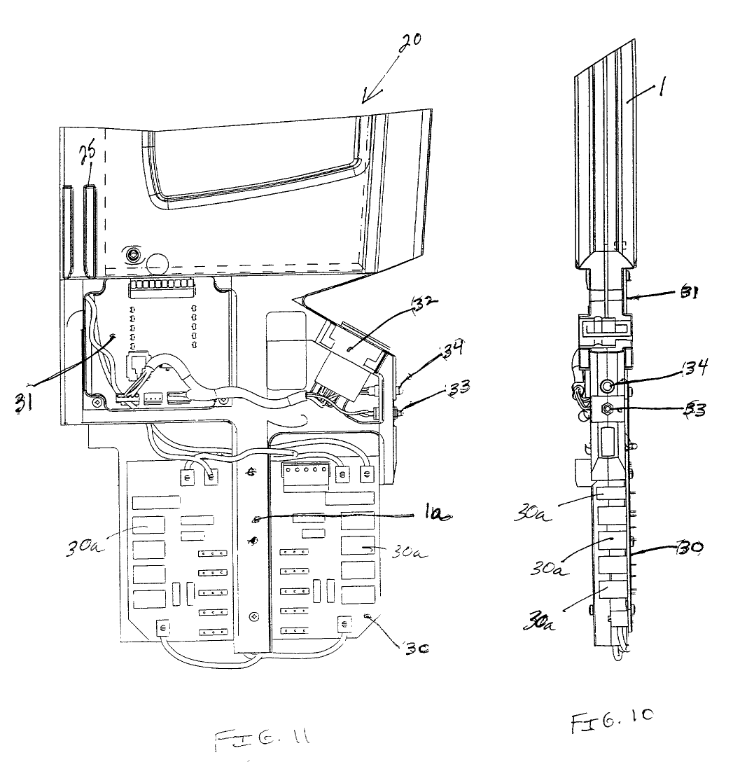

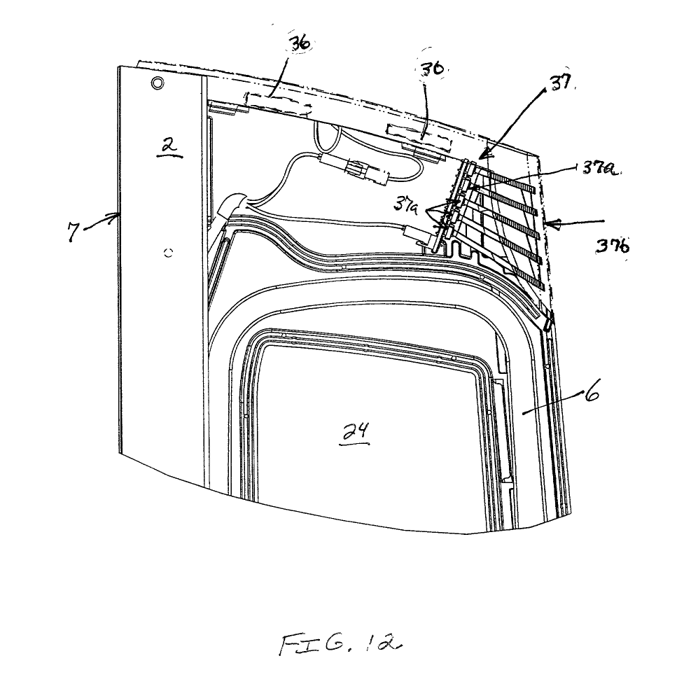

Referring to FIGS. 8, 9, 10, and 11, electronics enclosure (3) can be located near the bottom of the antenna assembly (20). The enclosure (3) contains various electronic assemblies, which provide functionality to the antenna assembly (20). Internal PCB assemblies (30, 31) mount directly to the antenna housing panels (1a, 1b). The PCB assemblies (30, 31) and mounting locations (1c) in the antenna housing panels (1a, 1b) are arranged such that the PCB assemblies (30, 31) can be reversed or flipped around 180 degrees and attached to either side of the panels (1a, 1b). FIGS. 8 and 9 illustrate PCB assemblies (30, 31) attached to panel (1b) and FIGS. 10 and 11, illustrate attachment to panel (1a). PCB electronic components (30a) are kept inline with antenna assembly (20), as shown in FIGS. 8-11, to maintain the minimum thickness possible for antenna assembly (20). With the reversible mounting capability of PCB assembles (30, 31), antenna assembly (20) can be attached to a vertical structure adjacent a wall, and the PCB assemblies (30, 31) can be mounted in a manner that enables easy access to the components mounted thereto. An alarm counter (32), system control switch (33), and status LED (34) are mounted to the antenna housings such that they are accessible to the user on the edge of the antenna assembly (20) opposite the mounting base (2). An electronics enclosure cover (35) is provided to shield the electronics from view and inadvertent contact, and to protect the electronic assemblies from potential damage. The cover (35) is attached to mounting bracket (36) by a single screw (26). The cover (35) is constructed from a high strength material, such as but not limited to glass filled polyester to provide adequate durability and strength.

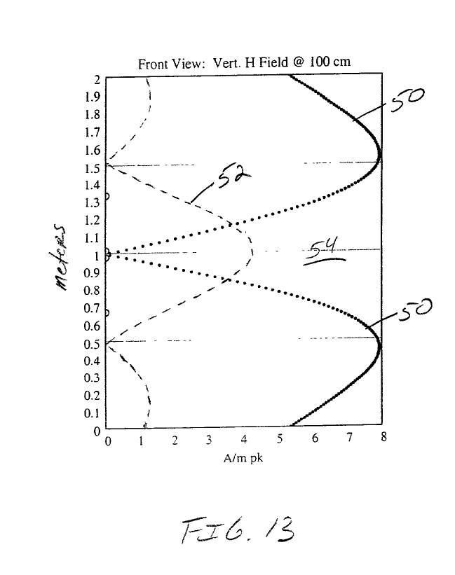

Referring to FIG. 12, alarm assembly (4) is provided at the top of the antenna assembly (20) to alert personnel when an EAS marker (12) moves through interrogation zone (11). The alarm assembly (4) provides both audible and visual notification to authorized personnel. The audible function can be provided using several types of audible devices such as but not limited to piezo electric transducers (36). The alarm light (37) is located on the top corner opposite the mounting surface (7) to provide the optimum visibility. The light can be generated using a variety of devices, such as but not limited to, high intensity LEDs (37a) to provide high illumination and alarm visibility for a broad range of ambient lighting conditions. The alarm light assembly (4) is covered by a lens (37b) for protection, and to provide a distinctive appearance.

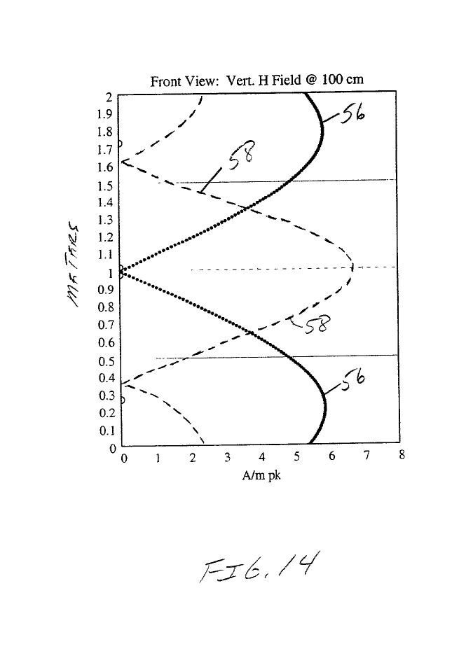

Referring to FIG. 13, the response of the vertical field is illustrated for two slightly overlapping coils forming an antenna with an aspect ratio of 1.89 to 1. The curves plot meters in height from the floor versus amps per meter of H-field for the vertical component of the coils. As shown, the resultant field comprises the combination of the in phase response (50) and out of phase response (52). An EAS marker may not be detected in area 54.

Referring to FIG. 14, a similar plot illustrates the resulting field for two slightly overlapping coils forming an antenna with an aspect ratio of 8.85 to 1. The coils in FIGS. 13 and 14 have the same area and are driven by the same coil current in order to isolate the effect of aspect ratio on antenna performance. The resultant field comprises the combination of the in phase response (56) and out of phase response (58). As illustrated, there is no area that corresponds to area (54) as in FIG. 13 that EAS markers will not be detected. As shown, the vertical field is enhanced by the elongated aspect ratio.

It is to be understood that variations and modifications of the present invention can be made without departing from the scope of the invention. It is also to be understood that the scope of the invention is not to be interpreted as limited to the specific embodiments disclosed herein, but only in accordance with the appended claims when read in light of the forgoing disclosure.

What is claimed is:

1. A pulsed magentic electronic article surveillance antenna mountable to a vertical member, comprising:
at least two coils adapted for generating an electromagnetic field for detecting an electronic article surveillance marker, said coils being elongated in the vertical direction and stacked substantially end to end in substantially the same plane defining an electronic article surveillance antenna having a vertical to horizontal aspect ratio that is relatively much greater in the vertical direction than the horizontal direction wherein said antenna appears relatively tall and narrow, said coils being driven substantially in phase and out of phase with each other to generate said electromagnetic field; and,
an antenna housing adapted to receive said coils, said housing being attachable to a vertical member wherein said electromagnetic field generated from said coils is projected substantially into an opening adjacent the vertical member for passage of the electronic article surveillance marker to be detected.

2. The apparatus of claim 1 wherein said coils at least partially overlap near the center of said antenna.

3. The apparatus of claim 1 wherein said vertical to horizontal aspect ratio is greater than about 7 to 1.

4. The apparatus of claim 3 wherein said vertical to horizontal aspect ratio is about 9 to 1.

5. The apparatus of claim 1 further comprising an elongated mounting base having means for connection to the vertical member, said antenna housing having means for attachment to said mounting base.

6. The apparatus of claim 5 wherein said antenna housing is removably and rigidly attachable to said mounting base.

7. The apparatus of claim 1 wherein said antenna housing includes an electronic housing portion for receiving at least one printed circuit board.

8. The apparatus of claim 7 wherein said electronic housing portion being adapted to receive said printed circuit board in a first and a second, reversed orientation for selective installation in said electronic housing portion.
